(19) United States
(12) Patent Application Publication
(10) Pub. No.: US 2009/0281843 A1
(43) Pub. Date: Nov. 12, 2009

(54) CALENDAR SCHEDULING SYSTEMS

(75) Inventors: Patrick L. Coffman, San Francisco, CA (US); Haley E. Allen, Santa Clara, CA (US); Stacey Ford Lysik, San Jose, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(73) Assignee: Apple Inc., Cupertino, CA (US)

(21) Appl. No.: 12/240,798

(22) Filed: Sep. 29, 2008

Related U.S. Application Data
(60) Provisional application No. 61/051,664, filed on May 8, 2008.

(51) Int. Cl. G06Q 10/00

(52) U.S. Cl. 705/5; 705/8

(57) ABSTRACT

Calendar scheduling systems are described. In one embodiment, a client system receives an input, within a calendar application program, to schedule an event, the input specifying at least one of the event, a representation of a location for the event, or metadata of a physical facility at the location, and the client system transmits the input to a calendar server to determine an availability of at least one physical facility at the location and receives and presents data specifying the availability of at least one physical facility at the location. The client system may further cause an invitation to be sent to attendees of the event. Other systems and other methods are also described.

This application is related to and claims the benefit of the filing date of U.S. Provisional Application No. 61/051,664, filed on May 8, 2008.

### FIELD OF THE INVENTION

The present invention relates to calendar scheduling systems.

### BACKGROUND

Electronic calendars allow users to store events and reminders and other information in a data processing system. These calendars are similar to paper-based calendars and can be used to remind the users of meetings, birthdays, social events, and other events. These electronic calendar systems are typically implemented through the use of a calendar application program, such as iCal on a Macintosh computer running Macintosh OS X or a computer program known as Outlook from Microsoft Corporation or other calendar applications such as Meeting Maker. Users may use these calendar applications to schedule meetings which make use of a physical facility such as a conference room or a projector or a television or other physical resources or facilities.

FIG. 1 shows an example of a prior art method for using an electronic calendar system to set up a meeting in a conference room. In this method, the user must repeatedly attempt to secure a conference room if conference rooms are heavily used. In operation 11, the user decides to set up a meeting in a conference room in a building, such as a building on a campus of many buildings. This is often the case for companies or other enterprises which have multiple buildings on a campus. In operation 13, the user selects a date and time for the meeting within the calendar program to create an invitation to the meeting. The calendar program may be the computer program known as Meeting Maker or the program known as Outlook or the program known as Entourage or other calendar programs known in the art. In operation 15, the user selects a conference room within a building; this may occur by entering the name of the conference room in an entry field in the application program. The program, in turn, transmits this name for the conference room to a calendar server, and in operation 17, the user waits for a response from the calendar server to see if the selected conference room is available. Then, it is determined in operation 19 whether the selected conference room is available. If it is not, then processing loops back to either operation 15 or potentially operation 13 if no conference rooms are available for the previously selected date and time. If the selected conference room is available, then it is reserved in operation 21 and the reservation is stored on the calendar server in operation 23. Then the invitations to the meeting can be sent out to the recipients or attendees which will be held in the reserved conference room. This described workflow is acceptable when there are a sufficient number of conference rooms available for use during any particular time. However, there may be times in which few, if any, conference rooms are available for meetings, and this requires the user to attempt several times to select a conference room to determine whether it is available before discovering that none are available.

### SUMMARY OF THE DESCRIPTION

In one embodiment, a calendar scheduling system implemented on a client system receives an input, within a calendar application program, to schedule an event and the input specifies at least one of the event, a representation of a location for the event, or metadata of a physical facility at the location. The client system transmits the input to a calendar server to determine an availability of at least one physical facility at the location. In response to this input, the calendar system receives and presents data specifying the availability of at least one physical facility at the location. The calendar system may further cause an invitation to be sent to attendees of the event. In another embodiment, a calendar server system receives an input to schedule an event, the input specifying at least one of the event, a representation of a location for the event, or metadata of a physical facility at the location. The calendar server system further transmits data specifying the availability of at least one physical facility at the location and receives a request to reserve the at least one physical facility at the location. In response to the reservation or request to send an invitation, the calendar server system transmits at least one invitation to an attendee of the event for which the at least one physical facility has been reserved.

Machine readable media, such as computer readable media storing executable program instructions, other data processing systems and other methods are also described in this disclosure.

### BRIEF DESCRIPTION OF THE DRAWINGS

The present invention is illustrated by way of example and not limitation in the figures of the accompanying drawings in which like references indicate similar elements.

FIG. 1 shows a method according to the prior art for scheduling a meeting in a conference room.

FIG. 2 shows an example of a network of systems which may be used according to one embodiment of the present invention.

FIG. 3A shows one or more calendar server databases which may be used in at least certain embodiments described herein.

FIG. 3B shows an example of a data structure, which may be stored in a calendar server database, for a building and the metadata associated with that building.

FIG. 3C shows an example of metadata which may be stored in a calendar server database in certain embodiments for a conference room.

FIG. 4 shows an example of a method which may be performed, in at least certain embodiments, on a calendar server system.

FIG. 5 shows an example of a method which may be performed, in at least certain embodiments, on a client system.

FIGS. 6A and 6B show examples of the user interface or a portion of the user interface of an electronic calendar system; FIG. 6A shows a monthly view while FIG. 6B shows a weekly view of the calendar system.

FIGS. 7A, 7B, 7C, 7D, 7E, 7F, and 7G show an example of a workflow for scheduling a meeting in a conference room according to one embodiment of the present invention.

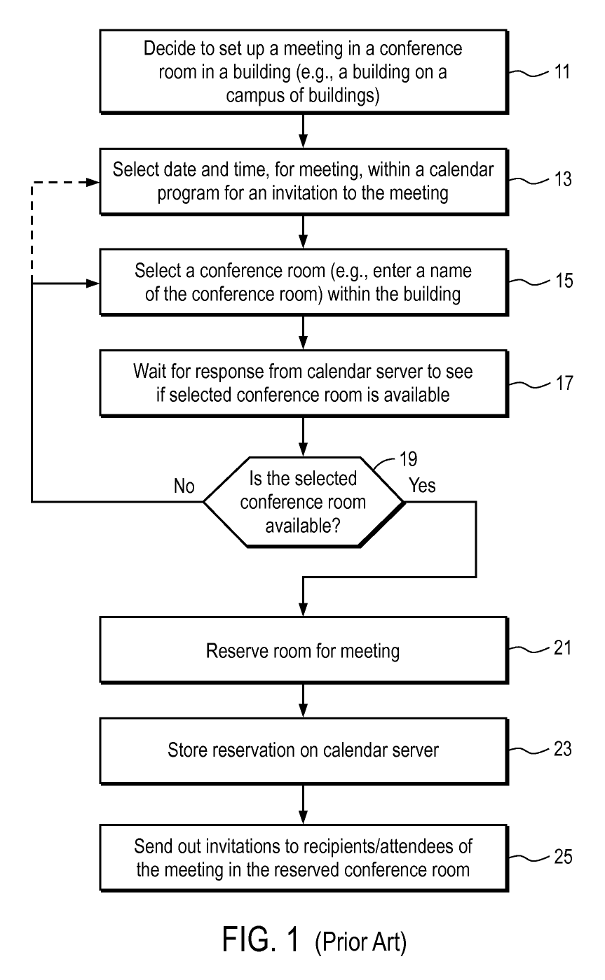

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to one embodiment or an embodiment means that a particular feature, structure or characteristic described in connection with the embodiment is included in at least one embodiment of the invention. The appearance of the phrase “in one embodiment” in various places in the specification do not necessarily refer to the same embodiment.

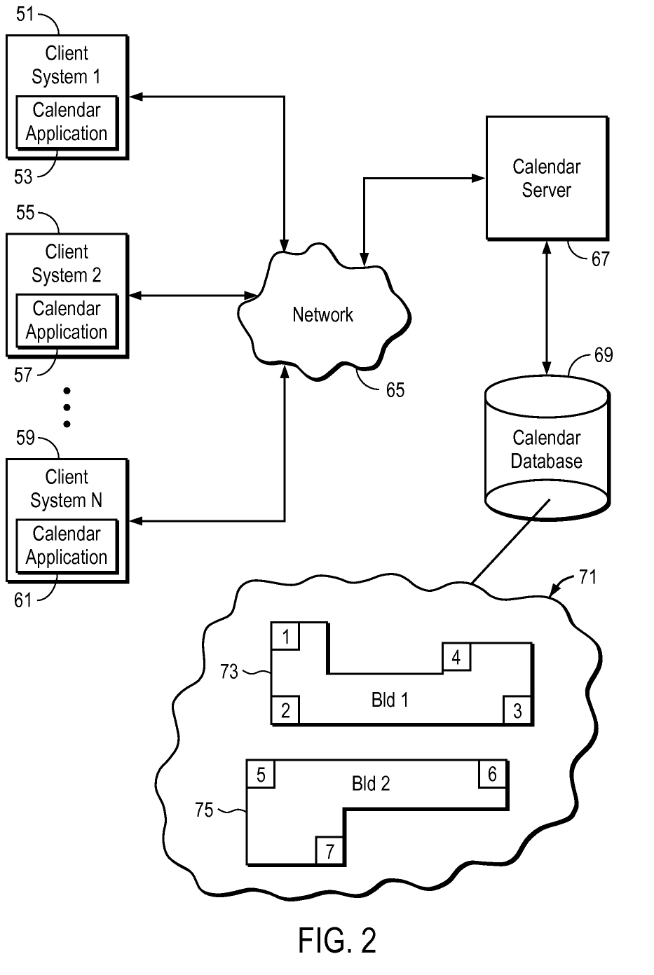

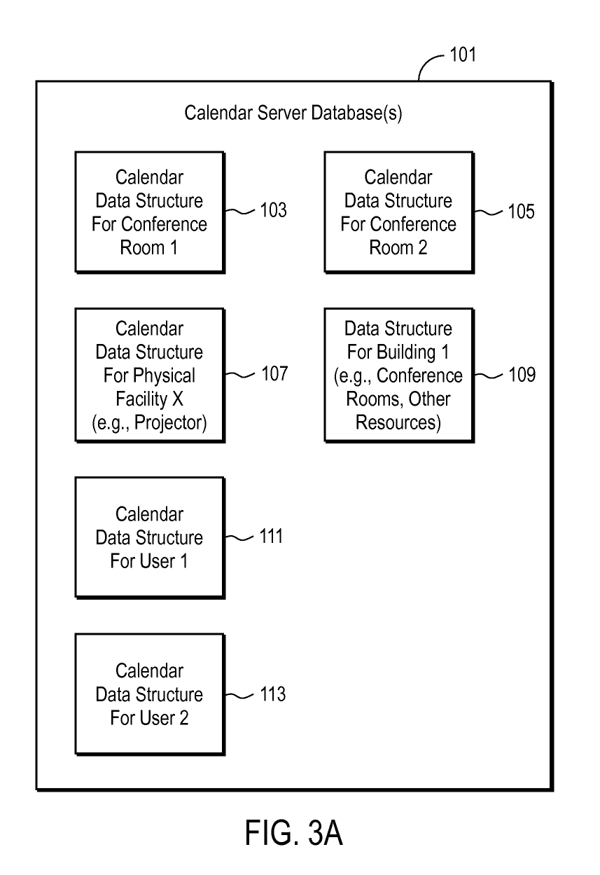

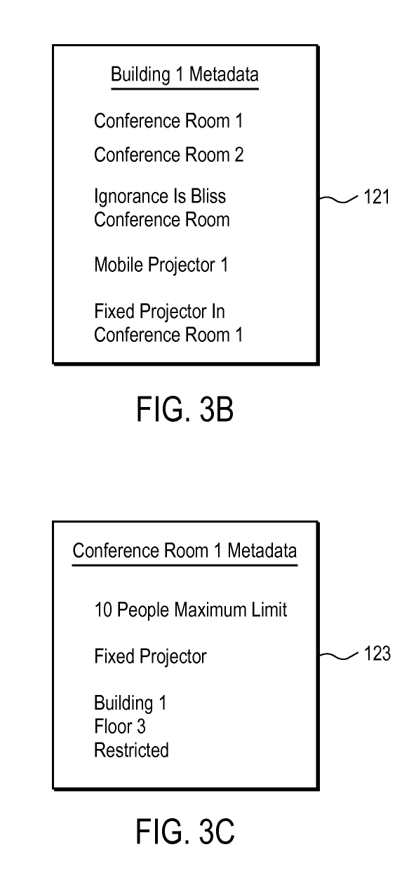

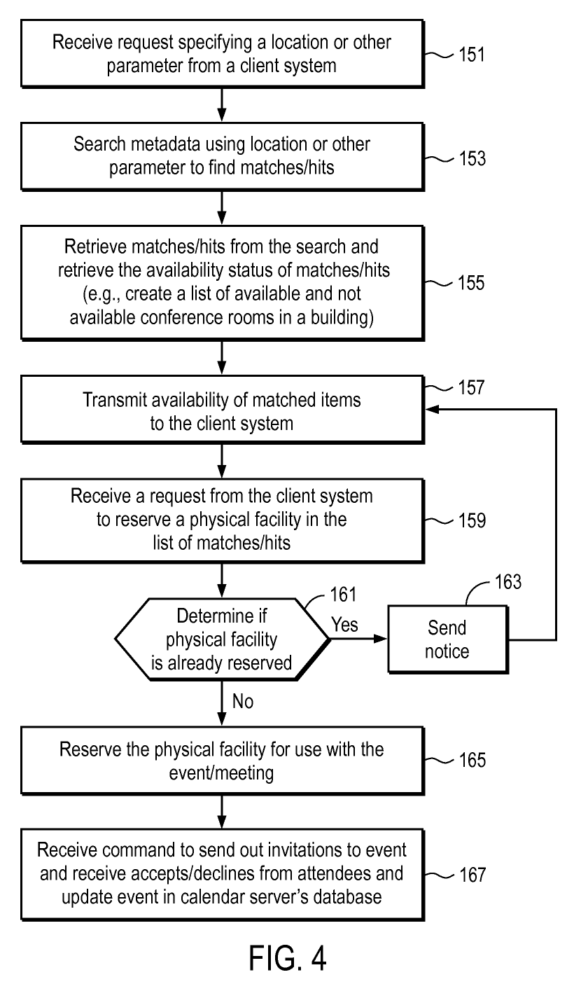

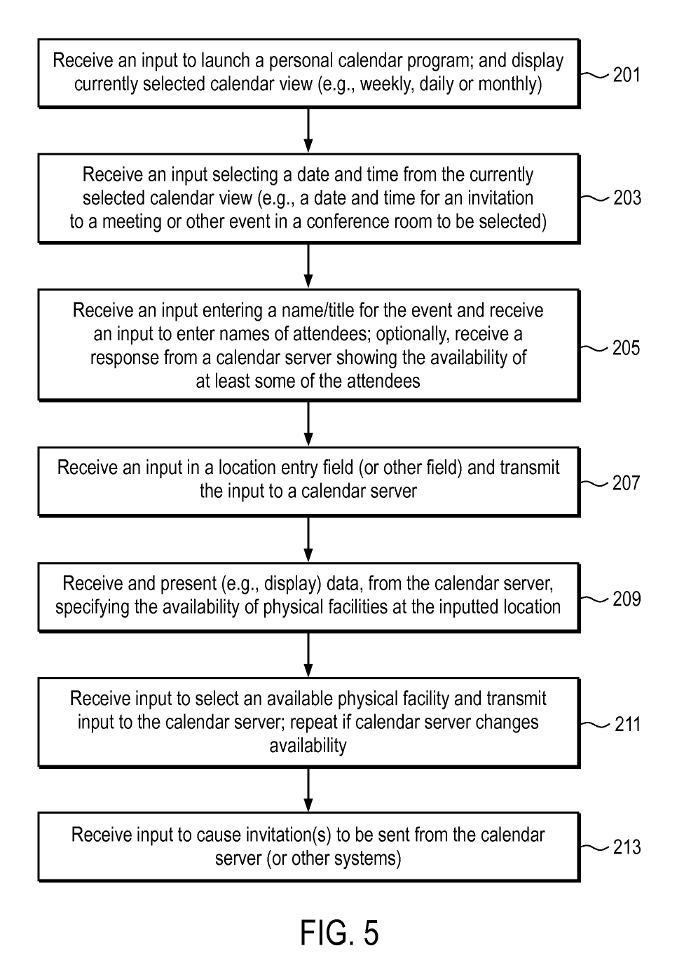

At least certain embodiments of the present invention may be implemented with multiple systems which are interconnected through a network such as a local area network or a wide area network or a plurality of networks, such as the Internet. These networks may be wired or wired and wireless, and the wireless connections may take the form of WiFi or WiMAX connections or other wireless connections, and the wired connections may take the form or Ethernet wires or fiber-optic, etc. FIG. 2 shows an example of a network 65 which may be any one of these networks which interconnect a plurality of systems, such as the client systems 51, 55 and 59, each of which includes a calendar application 53, 57, and 61, respectively, as shown in FIG. 2. These calendar applications may be one or more of the calendar application programs known as iCal or Outlook or Entourage or Meeting Maker or other calendar applications. Each of these calendar applications may be configured to communicate with a calendar server 67 which maintains a calendar database 69. The calendar server may be implemented on a general purpose data processing system or other data processing systems or other consumer electronic devices. It will be understood that a client system, such as the client system 51, may be a general purpose computer or a special purpose computer or a network computer, or a personal digital assistant (PDA) or a cellular telephone, or a handheld computer, or an entertainment system or other consumer electronic devices. Similarly, the calendar server system 67 may be implemented as a general purpose computer or a special purpose computer or other types of data processing systems and/or consumer electronic devices. In one embodiment, a client system, such as the client system 51, may be a Macintosh computer running the OS X operating system and the calendar server 67 may be a general purpose data processing system running the Windows operating system in addition to an Exchange server or other type of calendar server application program such as a CalDAV-compliant calendar server. In other embodiments, the client system or systems may be a variety of different systems, such as general purpose computers (e.g. a computer running the Windows operating system) or cellular telephones or handheld computers, such as an iPod Touch or an iPhone, etc. The calendar server 67 may be implemented as a set of servers in a back-end data center for an enterprise. The calendar application programs on each of the clients may be the same application program or different application programs. For example, the calendar application program 53 may be the application program iCal from Apple Inc. and the application program 57 may be the calendar application known as Outlook from Microsoft Corporation. The calendar database 69 may collect calendar information from each user or a set of users less than all of the users and may further include data structures, described further below and shown in FIGS. 3A, 3B and 3C relating to buildings and conference rooms and other physical facilities and resources within the buildings of an enterprise, such as a corporation. The graphical representation 71 shows an example of how a calendar database, such as the calendar database 67, may, through its data structures, store information about a variety of buildings, such as Building1 73 and Building2 75. Each of these buildings includes several conference rooms. In particular, Building1 includes conference rooms 1, 2, 3, and 4 while Building2 includes conference rooms 5, 6, and 7. In at least certain embodiments, the calendar database 69 can be used to schedule meetings in the various conference rooms using the methods shown in FIGS. 4 and 5 which provide, prior to committing to a particular conference room or selecting the conference room, feedback about the availability of conference rooms or other physical facilities or resources.

It will be appreciated that the calendar applications, such as applications 53, 57, and 61, may have sophisticated user interfaces, such as the user interfaces presented by the calendar application program iCal or the calendar application program Outlook or the calendar application program provided by the program known as Entourage. Examples of such user interfaces and features for a calendar application program are described in published U.S. Applications 2004/0109025 and 2005/0039142, which applications are hereby incorporated herein by reference.

FIGS. 3A, 3B, and 3C show examples of databases and/or data structures for storing calendar information for use by one or more users. It will be appreciated that there are a number of different ways of implementing these databases. In one embodiment, the calendar database 69 is represented by the calendar server database 101 which includes a plurality of different data structures for each conference room and for each building and for each physical facility, such as a projector or television or other resource. Further, the calendar server database 101 may include calendar data structures for each user or at least a set of users within an enterprise. This allows each user to see the availability, on a particular date and time, of other users for a meeting or other events. Other implementations may utilize different types of data structures which organize the data in a different fashion but which still provide the functionality of allowing for searching to be performed across multiple conference rooms and other physical facilities or resources and across multiple user calendars. The operation of the calendar server may conform to certain standard protocols to enable calendar access, such as CalDAV. The calendar data structures 103 and 105 may be thought of as a calendar maintained for each of the conference rooms, and the calendar data structure 107 may be thought of as a calendar maintained by the calendar server for a physical facility such as a projector or a television or other resource. The data structure 109 may be implemented in a variety of ways and store data relating to Building1, such as the searchable metadata 121 shown in FIG. 3B, which includes a list of conference rooms in the building and certain resources available within Building1, such as a mobile projector or a fixed projector in a particular conference room. As shown in FIG. 3B, Building1 includes 3 conference rooms in addition to 2 projectors. FIG. 3C shows an example of searchable metadata maintained for a particular conference room, which may be part of the data structure 103 shown in FIG. 3A. This metadata may include a capacity of the conference room, such as 10 people maximum, and the resources within the conference room, such as a fixed projector, and the location of the conference room (such as the location within Building1), and the floor of the conference room, and certain other information about the conference room, such as its status as a “restricted” conference room. The calendar server 67 may also store calendar data structures, such as data structures 111 and 113 for at least a set of users, which cause their calendars, or at least a portion of their calendars, to be maintained in the calendar database 69 so that other users can see the availability of those users. In effect, users allowing their calendars to be maintained in the calendar database 69 are providing or making their calendars public or accessible to other users. In this way, when a first user wants to schedule a meeting with a second user, the calendar server can provide the available times and dates of the second user to the first user when the first user is in the process of scheduling a meeting in order to send out an invitation to the second user.

It will be understood that in at least certain embodiments, the calendar server can perform searches of the data and metadata in the calendar database, including the metadata shown in FIGS. 3B and 3C. These searches can be in response to requests from users attempting to schedule meetings and set up conference rooms for those meetings as described further below.

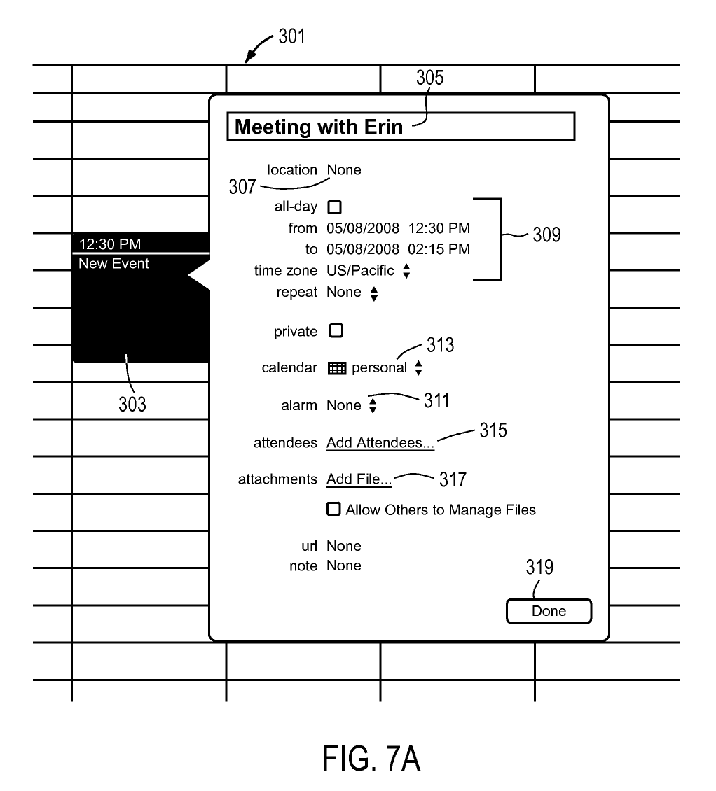

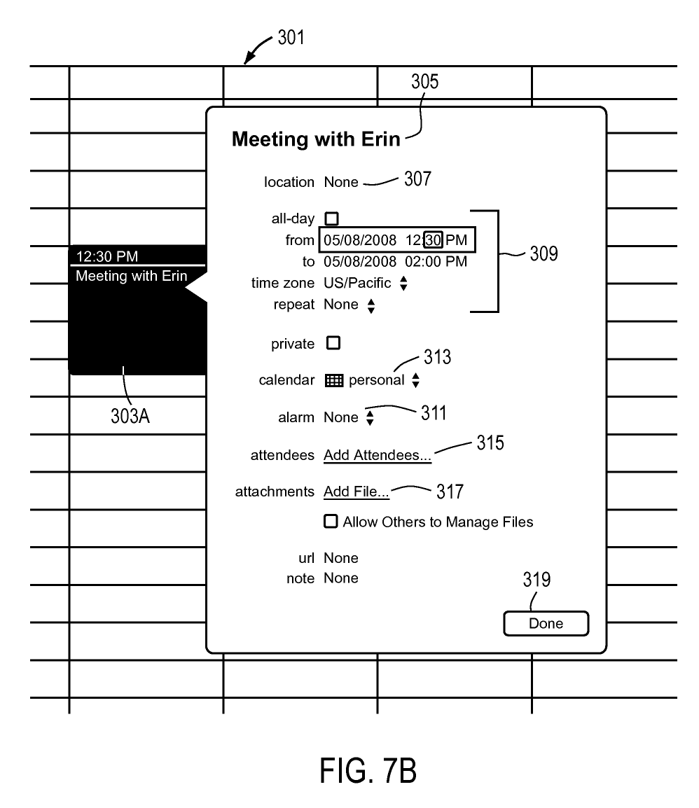

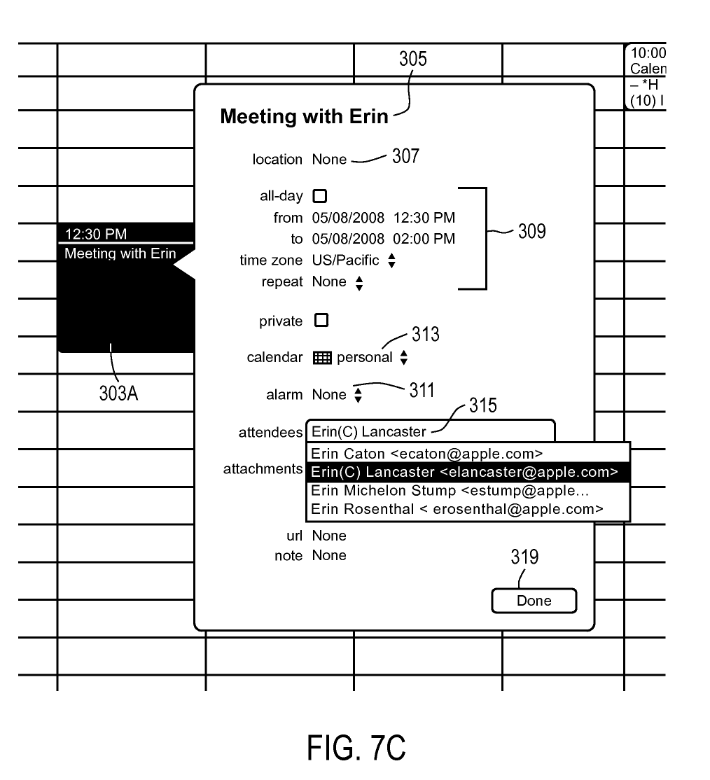

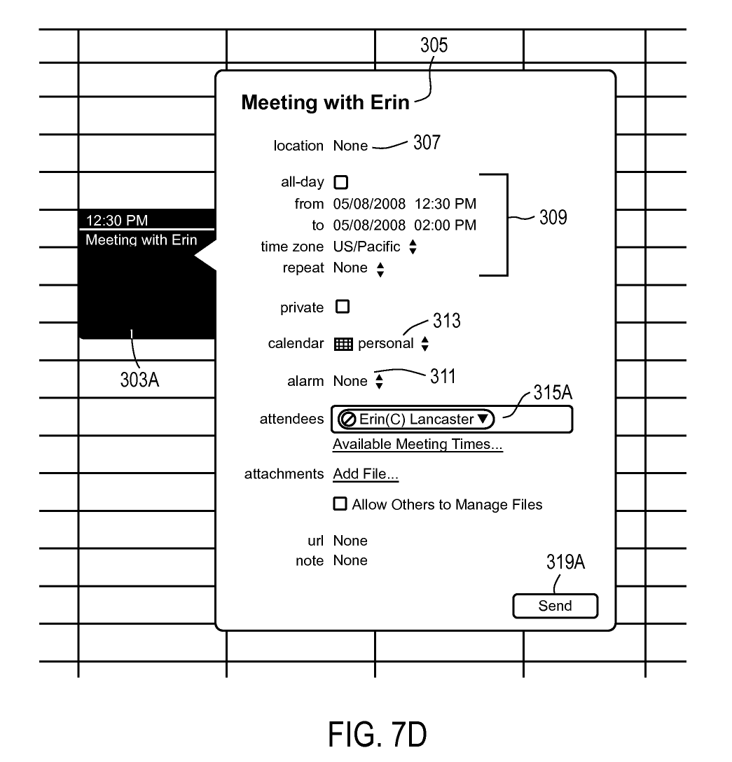

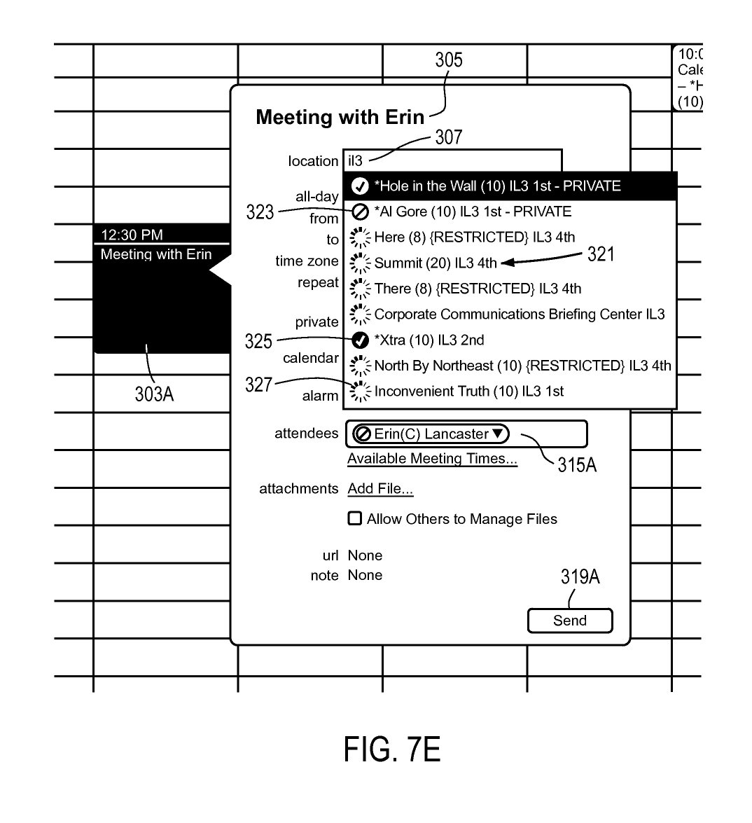

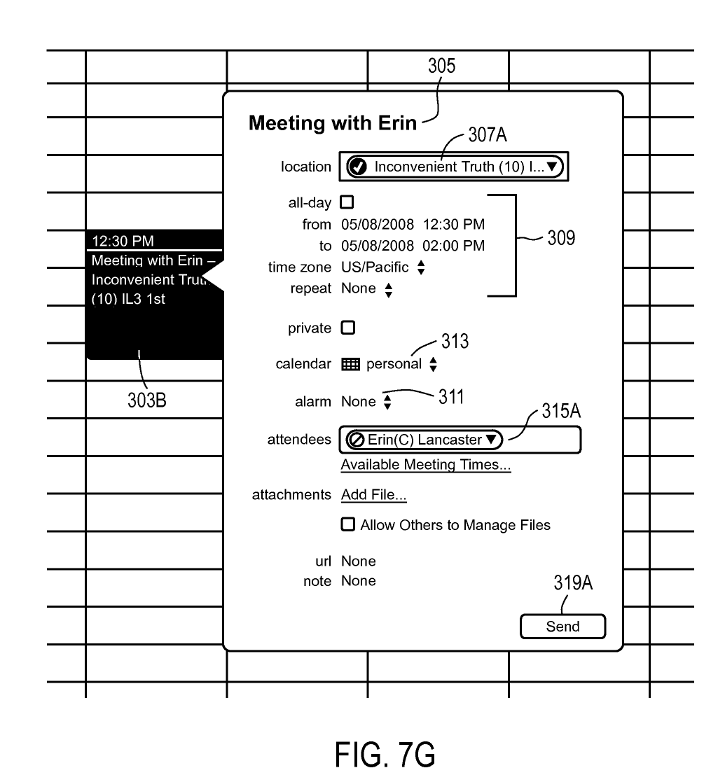

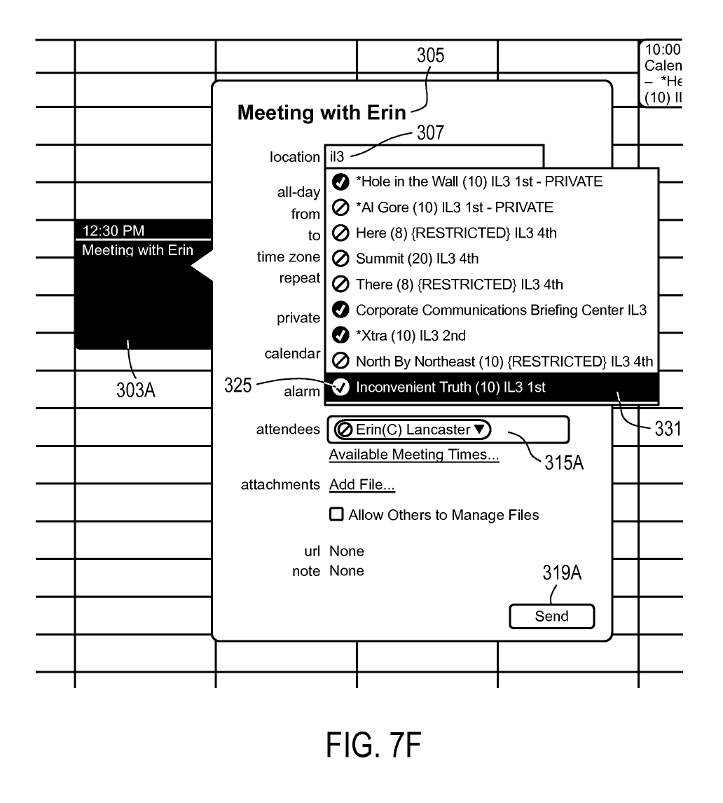

FIG. 4 shows an example of a method which may be performed by a calendar server which interacts with one or more client systems in the process of scheduling an event, such as a meeting, and also reserving a conference room within a building for that meeting. In operation 151, a request is received which specifies a location or other parameter from a client system. The location may be a particular building or information representing a particular building, such as a building name, etc., or the other parameter may be another type of input, such as a floor number or capacity of a conference room or the name of resources or facilities in a conference room, such as projector, television, etc. FIG. 7E shows an example in which the request has specified a location by identifying a building name (in this case IL3) and this request will cause a search to be performed through the metadata maintained in the calendar database 69 in one embodiment. This search is shown as operation 153 and may be performed by the calendar server 67 in conjunction with the calendar database 69. Then in operation 155, the calendar server, in one embodiment, retrieves the matches/hits from the search and retrieves the availability status of each of the matches/hits. For example, the calendar server can create a list of available and not available conference rooms in a particular building designated by the location specified by the request in operation 151. An example of such a list of available and not available conference rooms in shown in FIG. 7F. This list may be transmitted in operation 157 to the client system which made the request which was received in operation 151.

The user at the client system may review the list and request to reserve a specific physical facility such as a specific conference room or a resource in the building. This request is received in operation 159 as shown in FIG. 4. Then the system determines, in operation 161, whether the physical facility or resource is already reserved. It will be understood that, in at least certain embodiments, a calendar server system, such as the calendar server system 67, is continually monitoring requests from the client systems to which it is connected. In at least certain embodiments, the calendar server may implement a reservation system which reserves physical facilities on a first-come, first-reserved basis. In other words, whichever client system successfully first reserves a conference room or other resource for a given date and time, then that client system will secure the reservation, thereby causing the status to change from available to unavailable. This may result in situations in which a client system received a list which showed a particular conference room as being available when, in fact, after the availability data was sent to that client system, another client system secured the reservation of that particular conference room on the first-come, first-reserved basis. Hence, it is possible that operation 161 will determine that the physical facility is already reserved and hence need to send a notice, in operation 163, back to that client system with a new list of availability, in operation 157, as shown in FIG. 4. In other embodiments, the calendar server may implement a lock system which locks its calendar database for a particular client system while the client system which has sent the request is in the process of selecting a physical facility or other resource. If the physical facility is not already reserved, then, from operation 161, processing proceeds to operation 165 in which the calendar server, such as the calendar server 67, reserves the physical facility specified in the request in operation 159, for use with the meeting/event which is being scheduled. This is shown as operation 165. Then in operation 167, the calendar server receives a command to send out invitations to the event. This command may be part of the request to reserve the physical facility or may be a separate and subsequent command which occurs in the case of the workflow shown in the user interface examples of FIGS. 7A-7G. After sending out the invitations to the attendees of the event, the calendar server will typically, in certain embodiments, receive acceptances or declines from the attendees and will update the event in the calendar server's database in at least certain embodiments. In other words, the attendees will receive notices in their calendars or in other formats of the event and respond to the notice indicating whether they accept the notice and will attend the event or cannot accept the notice and will not attend the event. The responses from these attendees are received by the calendar server and the calendar server may update the event in each user calendar maintained by the calendar server. In at least certain embodiments, the calendar sever will optionally send updates to the event to each of the clients listed as an invited attendee so that each of the invited attendees can see who will attend and who will not attend the meeting. This updated information may be maintained at both the calendar server and at each client system and stored at both or, in certain embodiments, be maintained solely at the calendar server requiring each client system to connect to the calendar sever in order to see the updated event information.

FIG. 5 shows an example of a method which may be performed by a client system, such as the client system 51 which communicates with a calendar server, such as the calendar server 67 in the process of scheduling a meeting and reserving a conference room. It will be understood that the example shown in FIG. 5 shows certain operations in a specific sequence and that, in other embodiments, these operations may be performed in a different sequence. For example, operation 205 may precede operation 203.

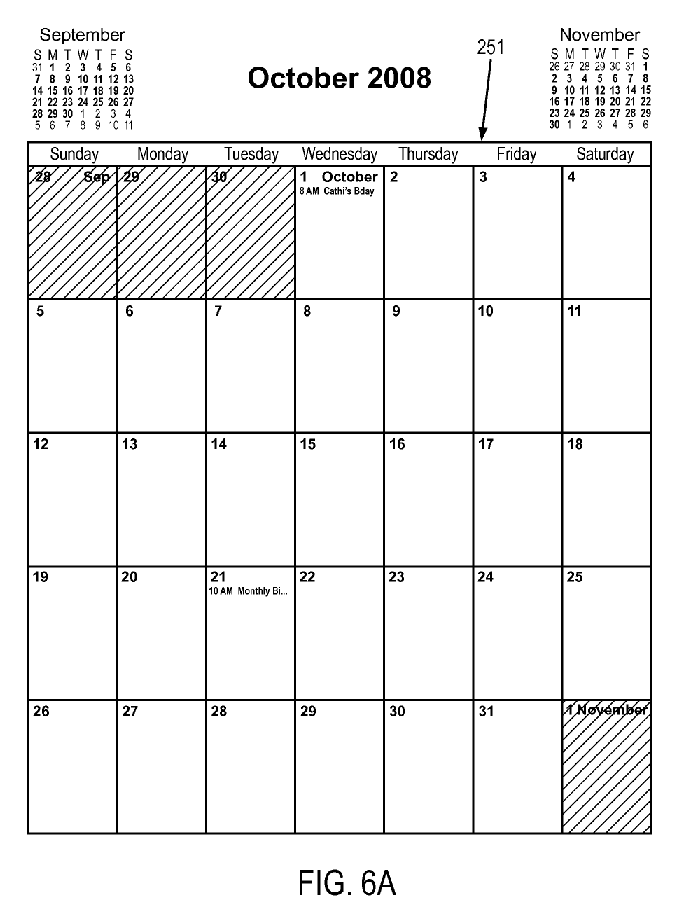

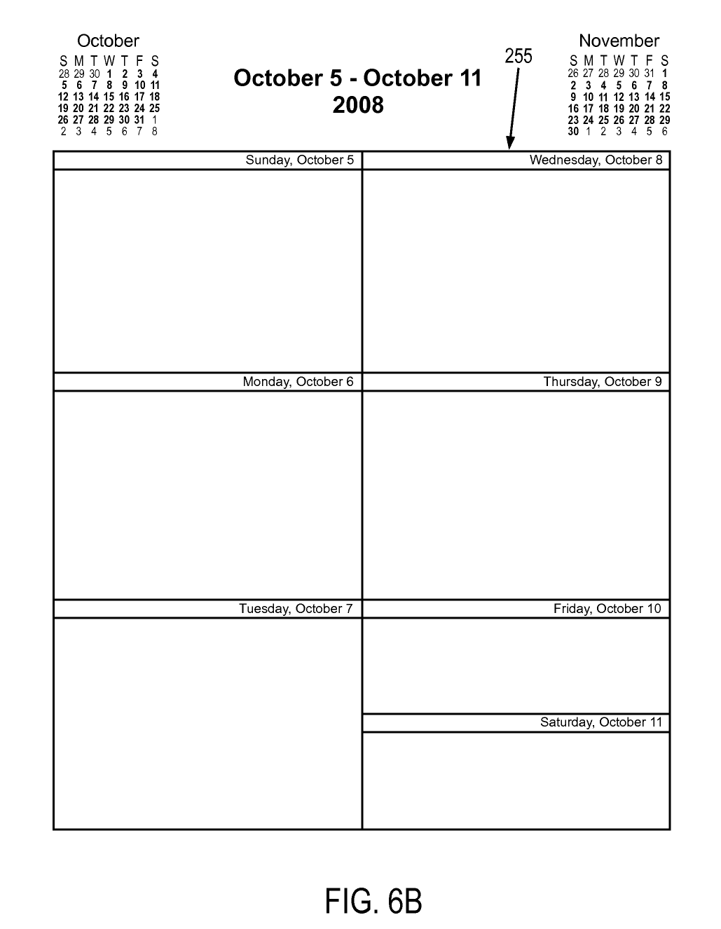

In operation 201, a client system receives an input to launch a personal calendar program, such as the calendar application program known as iCal or the calendar application program within Outlook, etc. In response to launching the application, the client system displays a currently selected calendar view, such as a weekly view or a daily view or a monthly view. FIG. 6A shows an example of a user interface of a calendar application program which is displaying a monthly view as the selected calendar view. FIG. 6B shows an example of a user interface of a calendar application program which is displaying a weekly view as the currently selected calendar view. A user can then select a particular day within a monthly view or a weekly view or a particular time on a daily view to select a date and time for an event, such as a meeting in a conference room to be selected. This is shown as operation 203. Then in operation 205, the client system receives an input entering a name or title for the event and further receives an input which enters names of attendees for the events. Optionally the client system may also receive a response from the calendar server showing the availability of at least some of the attendees so the user can determine whether or not the meeting should be scheduled at the selected time or rather to change to a different time to have more attendees be available for the meeting or other event. In operation 207, the client system receives an input in a location entry field or other field. This input may specify a location or metadata relating to the meeting, such as a projector or status of a conference room or capacity of a conference room, etc. This input is transmitted to the calendar server so that it can perform a search, such as the operation 155 described in conjunction with FIG. 4. The calendar server processes the input by performing a search, in at least certain embodiments, and retrieving certain data which is then transmitted to a client system. In operation 209, the client system receives and presents this data from the calendar server. This data may specify the availability of physical facilities and/or resources at the inputted location. An example of the presentation of such data is shown in FIG. 7F which shows the conference rooms which are available and not available at a particular date and time for a proposed meeting. The data, shown in this form in the example shown in FIG. 7F, may include physical resources such as projectors, televisions, and other resources or facilities. In operation 211, the client system receives an input to select an available physical facility, such as a conference room, and transmits this input to the calendar server. This may have to be repeated if the calendar server changes the availability due to the fact that another calendar system has reserved that same conference room prior to the reservation requested in operation 211. In at least certain embodiments, after the conference room is reserved and/or other physical facilities have been reserved, the user can cause an input, such as selecting the “send” button to cause an invitation to be sent to the attendees of the event. This invitation may be sent to all attendees or to a selected group of attendees and may be sent from the calendar server or another system to the client systems of each attendee. The message may appear in the other user's calendar or in an email message or in an instant message or in other forms. The recipients of these invitations may accept or decline the invitation and cause a response to be sent back to either or both of the calendar server and the client system which created the invitation. In this way, the event can be updated on either or both of the client system and the calendar server showing the status of the event with respect to who will attend and who will not attend.

An example of a user interface for performing the method shown in FIG. 5 on a client system which interoperates with a calendar sever performing the method of FIG. 4 is shown in FIGS. 7A-7G. In this particular example, a user of a client system is creating an event, which is a meeting in a conference room in a building on a campus which has multiple buildings, each having multiple conference rooms. The user is creating the event from within a currently selected calendar view, such as a weekly view, within a calendar application program, such as the calendar application program known as iCal from Apple Inc. of Cupertino, Calif. This particular calendar application program supports different types of calendars (referred to as calendar categories), such as home calendar, or work calendar or personal category, or other calendars which may be selectively viewed as is known in the art. The workflow depicted in FIGS. 7A-7G may begin by a user selecting a date and time from the currently selected calendar view; this selection may occur by positioning the mouse or pointer or by using a touchpad or touch screen to select the particular date and time. The user may click the mouse or drag a mouse to thereby drag a cursor over a period of time, etc. After selecting the period of time, the user interface presents an event region 303 in the currently selected calendar view 301 as shown in FIG. 7A. In addition, the user interface displays various data entry fields in a region associated with the event region 303 as shown in FIG. 7A. This region of entry fields includes a name entry field 305, a location field 307, a date and time field 309, a calendar category field 313, an alarm field 311, an attendee field 315, an attachment field 317, and a selectable button 319 which may be activated or selected by the user to indicate that the data entry for a new event has been completed.

As shown in FIG. 7A, the user has entered a title or name for the event in the name field 305; once this entry is completed, the name or title of the event will be updated as shown in the event region 303A of FIG. 7B. FIG. 7B also shows the user changing the date and time of the meeting through entries made into the date and time field 309. The user may also have previously selected a calendar category, in this case “personal” by making a selection in the calendar category field 313. The features of and user interfaces for calendar categories are described further in U.S. published application 2005/0039142, which is hereby incorporated herein by reference. The user may also have previously selected that no alarm is to be provided by making the appropriate selection in the alarm field 311. The user may then add attendees to the meeting as shown in FIG. 7C by entering names in the attendee field 315. Typing a few characters of a name may, in certain embodiments, cause an auto completion operation to be performed by matching that portion of the name with names stored in the database of available attendees, such as employees of a company, etc. As shown in FIG. 7C, the entry of Erin has caused an auto completion system to respond with four names, one of which has been selected by the user as the desired attendee and now appears in the attendee field 315 as shown in FIG. 7C. After the user selects the attendee, the attendee field 315A shows the attendee as depicted in FIG. 7D. In at least certain embodiments, the list of selected attendees or the list of possible attendees prior to selection of attendees, can display the availability of each attendee. This can be performed by the calendar server looking up the status of each attendee in their respective calendar data structure calendars, such as the calendar data structures 111 and 113 shown in FIG. 3A. The calendar server can then report back to the client system the availability, based on the stored calendars maintained by the calendar server for each of the proposed attendees. In the case of FIG. 7D, the selected attendee is not available as indicated by the “no” symbol in front of the name.

FIGS. 7E and 7F show an example of a user interface for providing feedback for a physical facility, such as a conference room, for the event which is being scheduled prior to committing or requesting the reservation of a particular conference room. As shown in FIG. 7E, the user on a client system has entered the location IL3 in the location field 307. The entry of this input corresponds to operation 207 which causes the transmission of the input to a calendar server which causes operations 151, 153 and 157 shown in FIG. 4 and performed by the calendar server. This causes a list of available and not available physical facilities which match the search request entered into the location field 307. In this example, a building name has been entered into the location field 307. In other examples, a conference room capacity (e.g. 10 people maximum limit) or a conference room feature, such as “restricted” or floor number or resource for a particular conference room may also be entered into the location field to cause a search through the metadata associated with the building and/or conference rooms or other physical facilities. The results of this search can also produce a list of available and not available facilities and resources in a list or other arrangement showing such available and not available facilities and resources. In one embodiment, the list may include both available and not available resources or merely include just available resources. The particular user interface shown in FIG. 7E includes both not available resources shown by the icon 323 and available resources shown by the icon 325. As shown in FIG. 7E, the calendar server is still processing the request with respect to other facilities, and so the availability is not yet presented as shown by the spinning icon 327 in FIG. 7E. If the user waits a sufficient amount of time, all of the spinning icons should be replaced with an indication of availability or non-availability of each of the resources or facilities retrieved as a result of the entry of IL3 into the location field 307. This is shown in FIG. 7F which shows that the conference room “Inconvenient Truth,” which can hold 10 people in the building IL3 on the first floor of the building, is available. The user selects this conference room 331 which causes the user interface to change to the interface displayed in FIG. 7G in which the conference room “Inconvenient Truth” is shown as being selected in the location field 307A. Then the user can instruct the calendar server to send out invitations to this meeting by selecting the selectable button 313A.

The present invention can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CDROMs, and magnetic optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

FIG. 2B of U.S. Pat. No. 6,222,549, which is hereby incorporated herein by reference, shows one example of a data processing system, such as a computer system, which may be used with the present invention. Note that while this figure illustrates various components of a data processing system, it is not intended to represent any particular architecture or manner of interconnecting the components as such details are not germane to the present invention. It will also be appreciated that network computers, personal digital assistants (PDAs), cellular telephones, handheld computers, special purpose computers, entertainment systems and other data processing systems and consumer electronic devices which have fewer components or perhaps more components may also be used with the present invention. The system of this figure may, for example, be a Macintosh computer from Apple Inc.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; electrical, optical, acoustical or other form of storage systems.

It will be apparent from this description that aspects of the inventions may be embodied, at least in part, in software. That is, the techniques may be carried out in a computer system or other data processing system in response to its processor or processing system executing sequences of instructions contained in a memory, such as RAM, etc. In various embodiments, hardwired circuitry may be used in combination with the software instructions to implement the present inventions. Thus, the techniques are not limited to any specific combination of hardware circuitry and software, nor to any particular source for the instructions executed by the data processing systems.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine implemented method comprising:
receiving an input, within a calendar application program, to schedule an event, the input specifying at least one of the event, a representation of a location for the event, or metadata of a physical facility at the location;
transmitting the input to determine an availability of at least one physical facility at the location;
receiving data specifying the availability of at least one physical facility at the location; and
presenting, through a user interface, the data.

2. The method as in claim 1, wherein the location is a building which has a plurality of conference rooms which are at least some of the physical facilities at the location and wherein the method is performed at a client data processing system which is coupled to a calendar server system through a network, and wherein the transmitting is to the calendar server system.

3. The method as in claim 2 wherein the presenting comprises displaying the data and wherein the method further comprises:
receiving a selection of a physical facility presented in the user interface;
transmitting the selection to reserve the physical facility.

4. The method as in claim 3 further comprising:
causing at least one invitation to be sent to attendees of the event for which the physical facility has been reserved by the transmitting of the selection.

5. The method as in claim 4 further comprising:
receiving at least one acceptance or decline from an attendee to the event.

6. The method as in claim 4 further comprising:
receiving data, in response to a selection of at least one attendee, indicating an availability of the at least one attendee.

7. The method as in claim 5 further comprising:
receiving data, in response to a selection of at least one attendee, indicating an availability of the at least one attendee.

8. The method as in claim 7 further comprising:
receiving an input of a date and a time of the event from a currently selected view of a calendar of a user who is scheduling the event in order to cause invitations to be sent;
receiving an input of a title of the event from the user.

9. The method as in claim 8, wherein the metadata is at least one of an audio/visual equipment at the location or a capacity of a conference room.

10. A data processing system comprising:
means for receiving an input, within a calendar application program, to schedule an event, the input specifying at least one of the event, a representation of a location for the event, or metadata of a physical facility at the location;
means for transmitting the input to determine an availability of at least one physical facility at the location;
means for receiving data specifying the availability of at least one physical facility at the location; and
means for presenting, through a user interface, the data.

11. A machine readable medium storing executable program instructions to cause a system to perform a method comprising:
receiving an input, within a calendar application program, to schedule an event, the input specifying at least one of the event, a representation of a location for the event, or metadata of a physical facility at the location;
transmitting the input to determine an availability of at least one physical facility at the location;
receiving data specifying the availability of at least one physical facility at the location; and
presenting, through a user interface, the data.

12. The medium as in claim 11, wherein the location is a building which has a plurality of conference rooms which are at least some of the physical facilities at the location and wherein the method is performed at a client data processing system which is coupled to a calendar server system through a network, and wherein the transmitting is to the calendar server system.

13. The medium as in claim 12 wherein the presenting comprises displaying the data and wherein the method further comprises:
receiving a selection of a physical facility presented in the user interface;
transmitting the selection to reserve the physical facility.

14. The medium as in claim 13, wherein the method further comprises:
causing at least one invitation to be sent to attendees of the event for which the physical facility has been reserved by the transmitting of the selection.

15. The medium as in claim 14, the method further comprising:
receiving at least one acceptance or decline from an attendee to the event.

16. The medium as in claim 14, the method further comprising:
receiving data, in response to a selection of at least one attendee, indicating an availability of the at least one attendee.

17. The medium as in claim 15, the method further comprising:
receiving data, in response to a selection of at least one attendee, indicating an availability of the at least one attendee.

18. The medium as in claim 17, the method further comprising:
receiving an input of a date and a time of the event from a currently selected view of a calendar of a user who is scheduling the event in order to cause invitations to be sent;
receiving an input of a title of the event from the user.

19. The medium as in claim 18, wherein the metadata is at least one of an audio/visual equipment at the location or a capacity of a conference room.

20. A machine implemented method comprising:
receiving an input to schedule an event, the input specifying at least one of the event, a representation of a location for the event, or metadata of a physical facility at the location;
transmitting data specifying the availability of at least one physical facility at the location;
receiving a request to reserve the at least one physical facility at the location;
transmitting at least one invitation to an attendee of the event for which the at least one physical facility has been reserved.

21. The method as in claim 20 wherein the location is a building which has a plurality of conference rooms which are at least some of the physical facilities at the location and wherein the method is performed by a calendar server which is coupled to at least one client system through a network.

22. The method as in claim 21 further comprising:
receiving at least one acceptance or decline from an attendee of the event.

23. The method as in claim 22 further comprising:
transmitting data indicating the at least one acceptance or decline to the at least one client system.

24. The method as in claim 23 further comprising:
retrieving data, in response to receipt of a selection of at least one attendee, indicating an availability for the event of the at least one attendee;
transmitting the data indicating the availability for the event of the at least one attendee.

25. The method as in claim 24 further comprising:
receiving an input of a date and a time of the event and receiving an input of a title of the event and storing the date and the time and the title to provide in the at least one invitation.

26. The method as in claim 25 wherein the metadata is at least one of an audio/visual equipment at the location or a capacity of a conference room.

27. A data processing system comprising:
means for receiving an input to schedule an event, the input specifying at least one of the event, a representation of a location for the event, or metadata of a physical facility at the location;
means for transmitting data specifying the availability of at least one physical facility at the location;
means for receiving a request to reserve the at least one physical facility at the location;
means for transmitting at least one invitation to an attendee of the event for which the at least one physical facility has been reserved.

28. A machine readable medium storing executable program instructions to cause a system to perform a method comprising:
receiving an input to schedule an event, the input specifying at least one of the event, a representation of a location for the event, or metadata of a physical facility at the location;
transmitting data specifying the availability of at least one physical facility at the location;
receiving a request to reserve the at least one physical facility at the location;
transmitting at least one invitation to an attendee of the event for which the at least one physical facility has been reserved.

29. The medium as in claim 28 wherein the location is a building which has a plurality of conference rooms which are at least some of the physical facilities at the location and wherein the method is performed by a calendar server which is coupled to at least one client system through a network.

30. The medium as in claim 29, the method further comprising:
receiving at least one acceptance or decline from an attendee of the event.

31. The medium as in claim 30, the method further comprising:
transmitting data indicating the at least one acceptance or decline to the at least one client system.

32. The medium as in claim 31, the method further comprising:
retrieving data, in response to receipt of a selection of at least one attendee, indicating an availability for the event of the at least one attendee;
transmitting the data indicating the availability for the event of the at least one attendee.

33. The medium as in claim 32, the method further comprising:
receiving an input of a date and a time of the event and receiving an input of a title of the event and storing the date and the time and the title to provide in the at least one invitation.

34. The medium as in claim 33 wherein the metadata is at least one of an audio/visual equipment at the location or a capacity of a conference room.

35. A machine implemented method comprising:
receiving, at a first system, an input, from within a calendar application program running on a second system, to schedule an event, the input specifying at least one of the event, a representation of a location for the event, or metadata of a physical facility at the location, the input being received to determine an availability of at least one physical facility at the location;
transmitting, from the first system, data specifying the availability of at least one physical facility at the location to allow the data to be presented at the second system.

36. The method as in claim 35, wherein the location is a building which has a plurality of conference rooms which are at least some of the physical facilities at the location and wherein the method is performed at a calendar server system, which is the first system that is coupled through a network to the second system, and wherein the transmitting is to the second system.

37. The method as in claim 36 further comprising:
causing at least one invitation to be sent to attendees of the event for which the physical facility has been reserved by a selection at the second system.

38. The method as in claim 37 further comprising:
receiving at least one acceptance or decline from an attendee to the event.

39. The method as in claim 37 further comprising:
receiving data, in response to a selection of at least one attendee, indicating an availability of the at least one attendee.

40. The method as in claim 38 further comprising:
receiving data, in response to a selection of at least one attendee, indicating an availability of the at least one attendee.

41. The method as in claim 40, wherein the metadata is at least one of an audio/visual equipment at the location or a capacity of a conference room.

42. A data processing system comprising:
means for receiving, at a first system, an input, from a calendar application program running on a second system, to schedule an event, the input specifying at least one of the event, a representation of a location for the event, or metadata of a physical facility at the location, the input being received to determine an availability of at least one physical facility at the location;
means for transmitting, from the first system, data specifying the availability of at least one physical facility at the location to allow the data to be presented at the second system.

43. A machine readable medium storing executable program instructions to cause a system to perform a method comprising:
receiving, at a first system, an input, from a calendar application program running on a second system, to schedule an event, the input specifying at least one of the event, a representation of a location for the event, or metadata of a physical facility at the location, the input being received to determine an availability of at least one physical facility at the location;
transmitting, from the first system, data specifying the availability of at least one physical facility at the location to allow the data to be presented at the second system.

44. The medium as in claim 43, wherein the location is a building which has a plurality of conference rooms which are at least some of the physical facilities at the location and wherein the method is performed at a client data processing system which is coupled to a calendar server system through a network, and wherein the transmitting is to the calendar server system.

45. The medium as in claim 44, wherein the method further comprises:
causing at least one invitation to be sent to attendees of the event for which the physical facility has been reserved by a selection at the second system.

46. The medium as in claim 45, the method further comprising:
receiving at least one acceptance or decline from an attendee to the event.

47. The medium as in claim 45, the method further comprising:
receiving data, in response to a selection of at least one attendee, indicating an availability of the at least one attendee.

48. The medium as in claim 46, the method further comprising:
receiving data, in response to a selection of at least one attendee, indicating an availability of the at least one attendee.

49. The medium as in claim 48, wherein the metadata is at least one of an audio/visual equipment at the location or a capacity of a conference room.
